(19) United States
(12) Patent Application Publication
(10) Pub. No.: US 2016/0171920 A1
(43) Pub. Date: Jun. 16, 2016

(54) Display Apparatus and Image Control Method Thereof

(71) Applicant: InnoLux Corporation, Jhu-Nan (TW)

(72) Inventors: Cheng-Chung YANG, Jhu-Nan (TW); Fu-Cheng CHEN, Jhu-Nan (TW); Yu-Heng YANG, Jhu-Nan (TW)

(21) Appl. No.: 15/051,425

(22) Filed: Feb. 23, 2016

Related U.S. Application Data
(62) Division of application No. 13/947,779, filed on Jul. 22, 2013.

(30) Foreign Application Priority Data
Aug. 3, 2012 (TW) 101128113

(51) Int. Cl. G09G 3/20; G09G 3/32

(52) U.S. Cl. CPC G09G 3/2007; G09G 3/3233; G09G 2320/0626; G09G 2330/021; G09G 2360/16

(57) ABSTRACT

A display apparatus includes a display panel and a driving module. The driving module is electrically connected with the display panel and has an image processing circuit and a data driving circuit. The image processing circuit receives a first image signal of a frame time. When an average gray level of the first image signal is greater than or equal to a first setting gray level, the image processing circuit reduces gray levels of the first image signal according to a first ratio to obtain a second image signal. The data driving circuit receives the second image signal and drives the display panel to display an image according to the second image signal. An image control method of the display panel is also disclosed.

### CROSS REFERENCE TO RELATED APPLICATIONS

This application is a Divisional of co-pending application Ser. No. 13/947,779 filed on Jul. 22, 2013, which claims priority under 35 U.S.C. §119(a) on Patent Application No(s). 101128113 filed in Taiwan, Republic of China on Aug. 3, 2012. The entire contents of which are hereby incorporated by reference.

### BACKGROUND

1. Technical Field

The disclosed embodiments relate to a display apparatus and an image control method thereof, and in particular, to a self-luminous display apparatus and an image control method thereof.

2. Related Art

Organic light-emitting diodes (OLED) have advantages of self-emissive, high brightness, high contrast, compact, light, low power consumption, and fast response speed, so they have been applied to various kinds of display system, such as OLED display apparatuses, gradually. Based on different driving methods, the OLED display apparatuses are divided into a passive-matrix OLED display apparatus and an active-matrix OLED display apparatus. Due to the driving mode, however, the passive-matrix OLED display apparatus has shorter lifetime and is not suitable for large size display screen. On the contrary, the active-matrix OLED display apparatus has higher manufacturing cost and complex manufacturing processes, but it is suitable for large size display and high definition full-color display. Thus, the active-matrix OLED display apparatus has become the most popular technology in this art.

The equivalent circuit of the pixel of a conventional active-matrix OLED display apparatus includes two thin film transistors, a capacitance, and an organic light emitting element. One of the transistors serves as a switch and has a gate for receiving a scan signal and a drain for receiving a data signal. The other transistor serves as a driving element for controlling a current to driving the organic light emitting element to emit light. The data signal is inputted to the gate of the driving element, so that the luminance of the pixel of the organic light emitting element can be controlled by adjusting the voltage level of the data signal, thereby displaying an image.

FIG. 1A is a schematic graph showing the percentage in area of lighted pixels in all pixels of a conventional organic light emitting apparatus, and FIG. 1B is a schematic graph showing the percentage in area of the power consumption of the lighted pixels in all pixels of a conventional organic light emitting apparatus. The X-axes (horizontal) of FIGS. 1A and 1B represent the percentage in area of the lighted pixels in all pixels. The Y-axis (vertical) of FIG. 1A represents the ratio of the luminance of the lighted pixels to the luminance as all pixels are lighted, and the Y-axis (vertical) of FIG. 1B represents the power consumption of the display apparatus. As shown in FIG. 1A, the white area indicates the lighted pixels, while the black area indicates the non-lighted pixels.

In FIG. 1A, the point L represents that when the lighted pixels is 20% in area of all pixels, the luminance of the lighted pixels is about 136% of the luminance as all pixels are lighted. Herein, when the percentage of the lighted pixels is smaller, the luminance of the lighted pixels is higher, which is helpful in viewing the displayed image. Otherwise, when the percentage of the lighted pixels is larger, more pixels in the displayed image can emit light, so the luminance of the lighted pixels is preferably not increased in ratio. In other words, the luminance of individual lighted pixel decreases as the area of lighted pixels increases, so that the viewer can easily and clearly watch the display image.

As shown in FIG. 1B, when the percentage in area of the lighted pixels is higher, the power consumption of the organic light emitting apparatus is almost increased linearly.

Therefore, it is an important subject to provide a display apparatus and an image control method thereof that can provide different displaying strategies with respect to different displayed images for decreasing the power consumption of the display apparatus.

### SUMMARY

In view of the foregoing subject, an objective of the embodiment of the invention is to provide a display apparatus and an image control method thereof that can provide different displaying strategies with respect to different displayed images for decreasing the power consumption of the display apparatus.

To achieve the above objective, an embodiment of the invention discloses a display apparatus including a display panel and a driving module. The driving module is electrically connected with the display panel and includes an image processing circuit and a data driving circuit. The image processing circuit is configured for receiving a first image signal of a frame time. When an average gray level of the first image signal is greater than or equal to a first setting gray level, the image processing circuit reduces gray levels of the first image signal according to a first ratio to obtain a second image signal. The data driving circuit is configured for receiving the second image signal and driving the display panel to display an image according to the second image signal.

In one embodiment, the display apparatus is an OLED (organic light-emitting diode) display apparatus.

In one embodiment, the driving current of the display panel according to the first setting gray level is between 10% and 30% of a current for lighting all pixels of the display panel.

In one embodiment, when the average gray level is greater than or equal to the first setting gray level and is smaller than a second setting gray level, the image processing circuit reduces the gray levels of the first image signal according to the first ratio to obtain the second image signal.

In one embodiment, when the average gray level is greater than or equal to the second setting gray level, the image processing circuit reduces the gray levels of the first image signal according to a second ratio to obtain a third image signal.

In one embodiment, the driving current of the display panel according to the second setting gray level is between 65% and 75% of a current for lighting all pixels of the display panel.

In one embodiment, the second setting gray level is greater than the first setting gray level.

In one embodiment, the first ratio is between 0.9 and 0.75, and the second ratio is between 0.74 and 0.55.

In one embodiment, when the average gray level is greater than or equal to the first setting gray level and is smaller than a third setting gray level, the image processing circuit reduces the gray levels of the first image signal according to a third ratio to obtain a fourth image signal, and the third setting gray level is smaller than the second setting gray level.

In one embodiment, the data driving circuit outputs a data driving signal according the second image signal, the third image signal or the fourth image signal to drive pixels of the display panel to display an image.

In one embodiment, each of the pixels comprises a driving transistor and a light emitting element, the data driving signal is inputted to a gate of the driving transistor for controlling a luminance of the light emitting element.

To achieve the above objective, another embodiment of the invention also discloses an image control method of a display apparatus, which comprises a display panel and a driving module. The driving module is electrically connected with the display panel and comprises an image processing circuit and a data driving circuit. The image control method comprises the steps of: receiving a first image signal of a frame time by the image processing circuit; and when an average gray level of the first image signal is greater than or equal to a first setting gray level and is smaller than a second setting gray level, reducing gray levels of the first image signal by the image processing circuit according to a first ratio to obtain a second image signal.

In one embodiment, the driving current of the display panel according to the first setting gray level is between 10% and 30% of a current for lighting all pixels of the display panel.

In one embodiment, the image control method further comprises a step of: when the average gray level is greater than or equal to the second setting gray level and is smaller than a highest gray level, reducing the gray levels of the first image signal by the image processing circuit according to a second ratio to obtain a third image signal.

In one embodiment, the driving current of the display panel according to the second setting gray level is between 65% and 75% of a current for lighting all pixels of the display panel.

In one embodiment, the first ratio is between 0.9 and 0.75, and the second ratio is between 0.74 and 0.55.

In one embodiment, the image control method further comprises a step of: when the average gray level is greater than or equal to the first setting gray level and is smaller than a third setting gray level, reducing the gray levels of the first image signal by the image processing circuit according to a third ratio to obtain a fourth image signal, wherein the third setting gray level is smaller than the second setting gray level.

In one embodiment, the image control method further comprises a step of: outputting a data driving signal by the data driving circuit according the second image signal, the third image signal or the fourth image signal to drive the display panel to display an image.

In one embodiment, the image control method further comprises a step of: controlling pixels of the display panel to emit light by the data driving signal.

In one embodiment, the image control method further comprises a step of: inputting the data driving signal to a gate of a driving transistor of each of the pixels for controlling a luminance of a light emitting element of the pixel.

To achieve the above objective, another embodiment of the invention further discloses a display apparatus, comprising a display panel and a driving module. The driving module is electrically connected with the display panel and drives the display panel to display an image. A luminance of lighted pixels of the display panel and a lighting area percentage of the display panel form a curve. A part of the curve before a first lighting area percentage has a first slope, and a part of the curve after the first lighting area percentage has a second slope. The absolute value of the second slope is greater than that of the first slope.

In one embodiment, the first lighting area percentage is between 10% and 30%.

In one embodiment, a part of the curve after a second lighting area percentage has a third slope, which is different from the second slope, and the second lighting area percentage is greater than the first lighting area percentage.

In one embodiment, the second lighting area percentage is between 65% and 75%.

In one embodiment, the absolute value of the second slope is greater than that of the third slope.

In one embodiment, the luminance of the lighted pixels of the display panel is a luminance of a highest gray level.

As mentioned above, an image processing circuit of the display apparatus of the embodiment of the invention receives a first image signal of a frame time, and when an average gray level of the first image signal is greater than or equal to a first setting gray level, the image processing circuit reduces gray levels of the first image signal according to a first ratio to obtain a second image signal. Then, a data driving circuit of the display apparatus receives the second image signal and drives a display panel to display an image according to the second image signal. Compared with the conventional art, the embodiment of the invention can control the data driving circuit to output modified gray level voltage based on the gray levels of different display images, so that the display panel has lower driving current, thereby decreasing the power consumption of the display apparatus.

### BRIEF DESCRIPTION OF THE DRAWINGS

The embodiments will become more fully understood from the detailed description and accompanying drawings, which are given for illustration only, and thus are not limitative of the present invention, and wherein:

FIG. 1A is a schematic graph showing the percentage in area of lighted pixels in all pixels of a conventional organic light emitting apparatus;

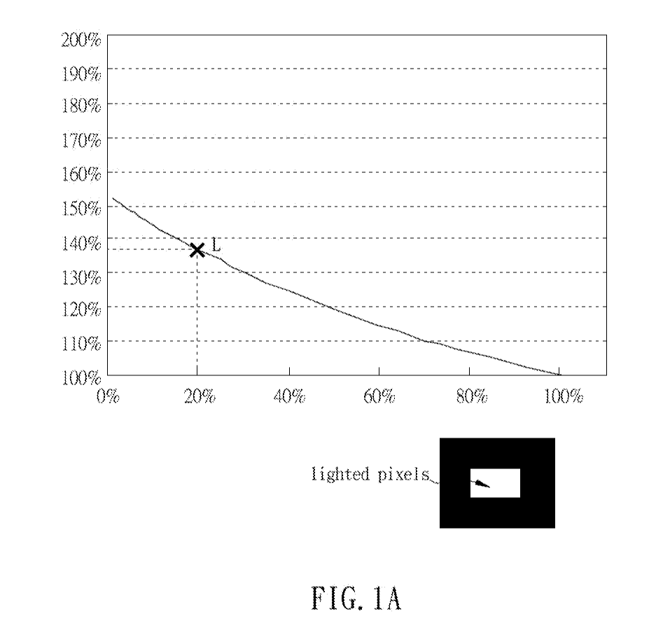

FIG. 1B is a schematic graph showing the percentage in area of the power consumption of the lighted pixels in all pixels of a conventional organic light emitting apparatus;

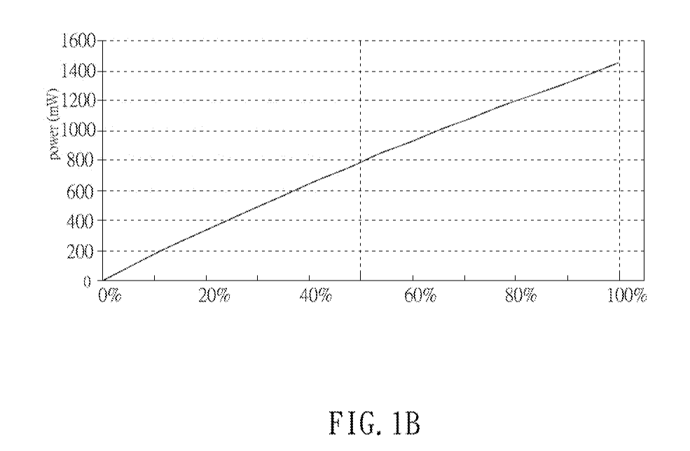

FIG. 2 is a block diagram of a display apparatus according to an embodiment of the invention;

FIG. 3 is a flow chart of an image control method of the display apparatus according to an embodiment of the invention;

FIG. 4A is a schematic graph showing the luminance of lighted pixels versus the percentage in area of lighted pixels in all pixels of two different display apparatuses by using the image control method of the embodiment of the invention; and

FIG. 4B is a schematic graph showing the power consumption versus the percentage in area of the lighted pixels in all pixels of two different display apparatuses by using the image control method of the embodiment of the invention.

### DETAILED DESCRIPTION OF THE INVENTION

The embodiments of the invention will be apparent from the following detailed description, which proceeds with reference to the accompanying drawings, wherein the same references relate to the same elements.

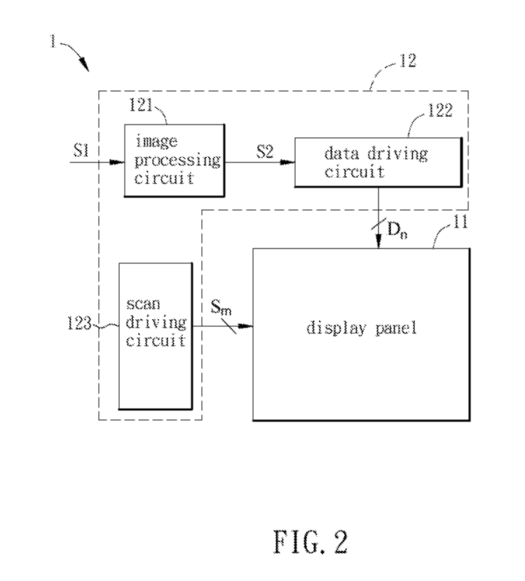

FIG. 2 is a block diagram of a display apparatus 1 according to an embodiment of the invention.

The display apparatus 1 of the embodiment is a self-luminous display apparatus. In this embodiment, the display apparatus 1 is an active-matrix organic light-emitting diode display apparatus. Of course, the display apparatus 1 can be other self-luminous display apparatus. As shown in FIG. 2, the display apparatus 1 includes a display panel 11 and a driving module 12.

The display panel 11 includes at least a pixel, and the driving module 12 drives the display panel 11 through at least one scan line and at least one data line. In this embodiment, the display apparatus 1 includes a plurality of pixels (not shown in FIG. 2), a plurality of scan lines Sₘ, and a plurality of data lines Dₙ. The scan lines Sₘ and data lines Dₙ are interlaced to define the pixel array. The display panel 11 is electrically connected to the driving module 12 through the scan lines Sₘ and data lines Dₙ.

The driving module 12 includes an image processing circuit 121, a data driving circuit 122, and a scan driving circuit 123. In more detailed, the scan driving circuit 123 is electrically connected to the display panel 11 through the scan lines Sₘ, and the data driving circuit 122 is electrically connected to the display panel 11 through the data lines Dₙ. The scan driving circuit 123 outputs scan driving signals to separately turn on the scan lines Sₘ, and the data driving circuit 122 can transmit a data driving signal the a corresponding line of pixels through the data lines Dₙ so as to enable the display panel 11 to display an image. In addition, the driving module 12 further includes a time control circuit (not shown in FIG. 2), which is electrically connected to the data driving circuit 122 and the scan driving circuit 123, separately. The image processing circuit 121 can be integrated in the time control circuit for decreasing the circuit cost. Of course, the image processing circuit 121 can be an individual integrated circuit, and this embodiment is not limited.

The image processing circuit 121 is configured for receiving a first image signal S1 of a frame time, and calculating an average gray level of the first image signal S1. The frame time indicates the period for displaying a frame by the display apparatus 1, and the first image signal S1 carries the information of gray levels of all pixels of the display panel 11 in a display frame. In other words, the image processing circuit 121 firstly calculates an average gray level of all pixels in a display frame. Afterwards, when the average gray level is greater than or equal to a first setting gray level (first setting gray level≦average gray level), the image processing circuit 121 reduces gray levels of the first image signal S1 according to a first ratio to obtain a second image signal S2. In this case, the display panel 11 can emit light based on the first setting gray level, and the driving current of the display panel 11 according to the first setting gray level is between 10% and 30% of a current for lighting all pixels of the display panel 11.

This embodiment adopts 8-bits gray level. For example, the gray level of the display panel 11 is between 0 and 255. When the first setting gray level is 145, the current for driving the display panel 11 according to the first setting gray level (145) is about 30% of the driving current for lighting all pixels of the display panel 11 according to the highest gray level (255). The first ratio is between 0.9 and 0.75. In this embodiment, the first ratio is 0.8 for example. Accordingly, when the average gray level of the displayed frame is greater than or equal to 145, the image processing circuit 121 obtains a second image signal S2 by multiplying each gray level of the first image signal S1 by 0.8. For instance, when the gray level of a pixel of the first image signal S1 is 200, and the average gray level of the displayed frame is higher than 145, the gray level of the second image signal S2 is 160 (200×0.8=160).

When the calculated average gray level is greater than or equal to the first setting gray level and is smaller than a second setting gray level (first setting gray level≦average gray level≦second setting gray level), the image processing circuit 121 also reduces the gray levels of the first image signal S1 according to the first ratio to obtain the second image signal S2. Otherwise, when the calculated average gray level is greater than or equal to the second setting gray level (second setting gray level≦average gray level), the image processing circuit 121 reduces the gray levels of the first image signal S1 according to a second ratio to obtain a third image signal (not shown in FIG. 2). The first and second ratios can be the same or different, and the second ratio may be greater than the first ratio. The driving current of the display panel 11 according to the second setting gray level is between 65% and 75% of a current for lighting all pixels of the display panel 11. The second ratio is between 0.74 and 0.55. In this embodiment, the second ratio is 0.72, and the second setting gray level is 215, so that the driving current of the display panel 11 is 70% of the current for lighting all pixels of the display panel 11.

As mentioned above, the image processing circuit 121 calculates an average gray level of all pixels of a display frame, and when the average gray level is smaller than the first setting gray level (e.g. 145) and is greater than zero (0≦average gray level<first setting gray level), the first image signal S1 is not changed. When the average gray level is greater than or equal to the first setting gray level (e.g. 145) and is smaller than the second setting gray level (e.g. 215) (first setting gray level≦average gray level<second setting gray level), each gray level of the first image signal S1 is multiplied by a first ratio (e.g. 0.8) to obtain a second image signal S2. When the average gray level is greater than or equal to the second setting gray level (e.g. 215) and is smaller than the highest gray level (e.g. 255) (second setting gray level≦average gray level≦highest gray level), each gray level of the first image signal S1 is multiplied by a second ratio (e.g. 0.72) to obtain a third image signal. In this case, the first setting gray level is 145, the second setting gray level is 215, the first ratio is 0.8, and the second ratio is 0.72. The above parameters are for example only, and of course, they can be set as different values.

In the above example, the second setting gray level and the second ratio are set, but in other embodiments, the second setting gray level and the second ratio may not needed and only the first setting gray level and the first ratio are used in the calculation. In other words, in other embodiments, when the average gray level is greater than or equal to the first setting gray level and is smaller than the highest gray level (e.g. 255) (first setting gray level≦average gray level≦highest gray level), each gray level of the first image signal S1 is multiplied by a ratio to obtain a second image signal S2. Moreover, it is possible to set more setting gray levels and corresponding ratios such as a third setting gray level, a fourth setting gray level, a third ratio, a fourth ratio, and the likes. For example, the third setting gray level is designed between the first and second setting gray levels, and when the average gray level is greater than or equal to the first setting gray level and is smaller than the third setting gray level, the image processing circuit 121 reduces the gray levels of the first image signal according to a third ratio to obtain a fourth image signal. This embodiment is not limited to the above settings.

After the image processing circuit 121 generates the second image signal S2, the third image signal or the fourth image signal, the data driving circuit 122 receives the generated signal and drives the display panel 11 to display an image according to the received signal. In details, the data driving circuit 122 outputs a data driving signal according to the received signal to drive the display panel 11 to display an image. In other words, after receiving the image signal outputted from the image processing circuit 121, the data driving circuit 122 outputs a data driving signal corresponding to the received image signal for controlling the corresponding pixels of the display panel 11 to emit light so as to display the image.

In this embodiment, each pixel of the display panel 11 has a light emitting element (e.g. OLED) and a driving transistor for controlling the light emitting element to emit light. The data driving signal from the data driving circuit 122 is inputted to the gate of the driving transistor of each pixel through the data line Dₙ for controlling the luminance of the pixel. The image processing circuit 121 reduces the gray levels of the image signal as the average gray level of the display frame is greater than or equal to the first setting gray level, so all gray-level voltages of the data driving signal outputted from the data driving circuit 122 is decreased accordingly. The modification can simultaneously decrease the luminance of the pixels of the light emitting element as well as the driving current of the display panel 11 and the power consumption of the display apparatus 1.

To be noted, when the average gray level of the display frame is lower, which means that the ratio of the lighted pixels in the display apparatus 1 is smaller, the gray levels of the first image signal S1 is not modified for facilitating the viewer to clearly watch the displayed image. Otherwise, when the average gray level of the display frame is higher, which means that the ratio of the lighted pixels in the display apparatus 1 is larger and more pixels are controlled to emit light, the gray levels of the first image signal S1 is reduced so as to decrease the total luminance of the display apparatus 1. Although the total luminance of the displayed frame is decreased, the viewers may not easily sense the change due to that more pixels can emit light, so the image quality can be remained.

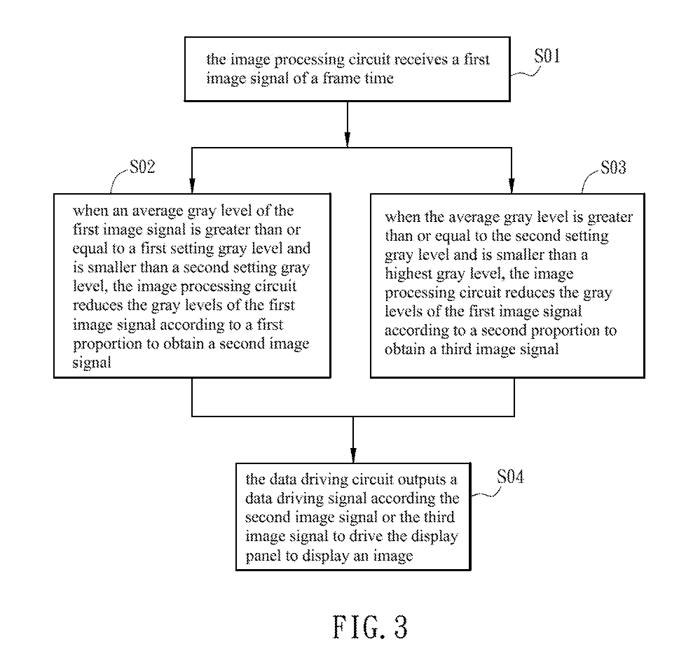

FIG. 3 is a flow chart of an image control method of the display apparatus according to an embodiment of the invention. The steps of the image control method will be described hereinafter with reference to FIGS. 2 and 3.

As shown in FIG. 2, the display apparatus 1 includes a display panel 11 and a driving module 12. The driving module 12 includes an image processing circuit 121, a data driving circuit 122 and a scan driving circuit 123. Hereinafter, the technical features of the display apparatus 1 can be referred to the above embodiment, so their description will be omitted.

Referring to FIG. 3, the image control method of the display apparatus according to this embodiment includes steps S01 to S04.

In the step S01, with reference to FIG. 2, the image processing circuit 121 receives a first image signal S1 of a frame time. In this case, a frame time presents the period for displaying a frame by the display apparatus 1. Moreover, the first image signal S1 includes gray levels for driving all pixels of the display apparatus 1 in a display frame.

In the step S02, when an average gray level of the first image signal S1 is greater than or equal to a first setting gray level and is smaller than a second setting gray level, the image processing circuit 121 reduces the gray levels of the first image signal S1 according to a first ratio to obtain a second image signal S2. Herein, the driving current of the display panel 11 according to the first setting gray level is between 10% and 30% of a current for lighting all pixels of the display panel 11. In addition, the first ratio is 0.8 and the first setting gray level is 145, so that the driving current of the display panel 11 is about 30% of the current for lighting all pixels of the display panel 11 according to the highest gray level (255).

In the step S03, when the average gray level is greater than or equal to the second setting gray level and is smaller than a highest gray level, the image processing circuit 121 reduces the gray levels of the first image signal S1 according to a second ratio to obtain a third image signal. Herein, the driving current of the display panel 11 according to the second setting gray level is between 65% and 75% of the current for lighting all pixels of the display panel 11. In this embodiment, the second ratio is 0.72 and the second setting gray level is 215, so that the driving current of the display panel 11 is about 70% of the current for lighting all pixels of the display panel 11.

Finally, in the step S04, the data driving circuit 122 outputs a data driving signal according the second image signal S2 or the third image signal S3 to drive the display panel 11 to display an image. In details, the data driving signal can control the pixels of the display panel 11 to emit light individually for displaying the image. In addition, the data driving signal is inputted to the gate of driving transistor of each pixel of the display panel 11 for controlling the luminance of the light emitting element of the pixel.

The other features of the image control method of the display apparatus are illustrated hereinabove, so the detailed descriptions thereof will be omitted hereinafter.

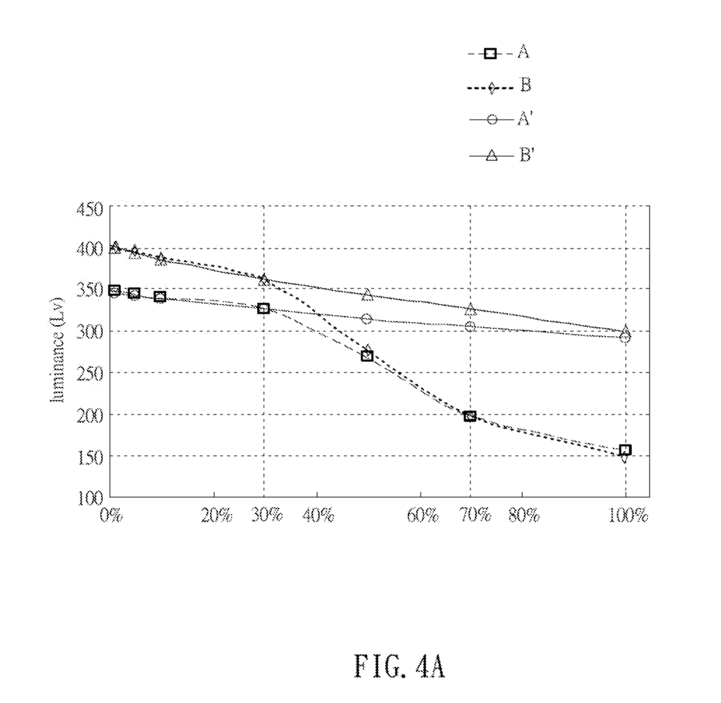

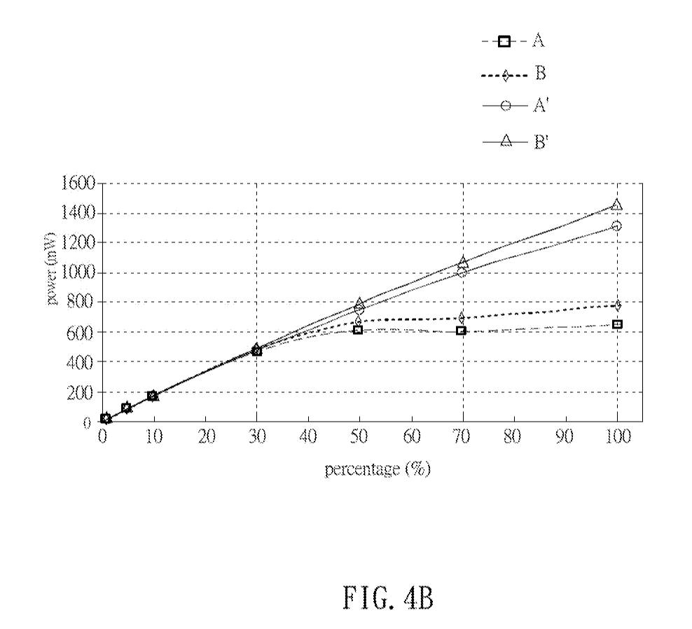

FIG. 4A is a schematic graph showing the luminance of lighted pixels versus the percentage in area of lighted pixels in all pixels of two different display apparatuses by using the image control method of the embodiment, and FIG. 4B is a schematic graph showing the power consumption versus the percentage in area of the lighted pixels in all pixels of two different display apparatuses by using the image control method of the embodiment. In this case, the ratio of the driving current of a display frame to the driving current for lighting all pixels (e.g. 30:100) is measured, and the measured ratio corresponds to a certain percentage in area of the lighted pixels. In addition, after the ratio of the currents for driving the display panel according to the average gray level and the highest gray level (all pixels are lighted), the percentage in area of the lighted pixels can be obtained by look-up table. Besides, the luminance of display panel as all pixels are lighted is equal to the luminance according to the highest gray level.

The X-axes (horizontal) of FIGS. 4A and 4B represent the percentage in area of the lighted pixels in all pixels. The Y-axis (vertical) of FIG. 4A represents the luminance of the lighted pixels, and the Y-axis (vertical) of FIG. 4B represents the power consumption of two display apparatuses. The solid lines A′ and B′ in FIGS. 4A and 4B represent two different display apparatuses without using the image control method of the embodiment, and the dotted lines A and B in FIGS. 4A and 4B represent two different display apparatuses with using the image control method of the embodiment.

In this embodiment, assuming the first setting gray level is 145, the current for driving the display panel 11 according to the first setting gray level is equal to 30% of the driving current for lighting all pixels of the display panel 11 according to the highest gray level (255). In this case, the percentage in area of the lighted pixels according to the first setting gray level is 30% (10% to 30% in this embodiment). As shown in FIG. 4A, when the percentage in area of the lighted pixels reaches 30% or more, the luminance indicated by the dotted lines A and B is obviously decreased based on the first ratio (0.8). Thus, as the percentage in area of the lighted pixels is larger than 30%, the curves (dotted lines A and B) are dramatically decreased. In other words, the part of the curves (dotted lines A and B) before a lighting area percentage of 30% has a first slope, and the part of the curves (dotted lines A and B) after the lighting area percentage of 30% has a second slope. The first and second slopes are different, and the absolute value of the second slope is greater than that of the first slope.

In this embodiment, assuming the second setting gray level is 215, the current for driving the display panel 11 according to the second setting gray level is equal to 70% of the driving current for lighting all pixels of the display panel 11. In this case, the percentage in area of the lighted pixels according to the second setting gray level is 70% (65% to 75% in this embodiment). When the percentage in area of the lighted pixels reaches 70% or more, the luminance indicated by the dotted lines A and B is further decreased based on the second ratio (0.72). In other words, as the percentage in area of the lighted pixels is larger than 70%, the curves (dotted lines A and B) are decreased by a third slope. The third slope is different from the second slope, and the absolute value of the second slope is greater than that of the third slope.

As shown in FIG. 4B, the power consumption of the display apparatus increases as the percentage in area of the lighted pixels is higher. After the percentage in area of the lighted pixels exceeds 30%, although the power consumption of the display apparatus with using the image control method of the embodiment (curves A and B) increases as the percentage in area of the lighted pixels is higher, it is obviously much lower than the power consumption of the display apparatus without using the image control method of the embodiment (curves A′ and B′).

For example, an OLED display apparatus is used to display a webpage, which usually has a high percentage of white portions. According to a statistic analysis result, the average power consumption of the OLED display apparatus for displaying a webpage is about 75% of the power consumption for displaying a white frame. In other words, the lighted pixels are about 75% in area of all pixels. Thus, the image control method of the embodiment can properly decrease the power consumption of the OLED display apparatus.

According to a statistic analysis result, the average power consumption of the OLED display apparatus for displaying a movie or TV frame is about 20% of the power consumption for displaying a white frame. In other words, the lighted pixels are about 20% in area of all pixels. Besides, the average power consumption of the OLED display apparatus for displaying a static image such as a photo is about 23% of the power consumption for displaying a white frame. In other words, the lighted pixels are about 23% in area of all pixels. In the above cases, although their power consumptions are relatively lower, the image control method of the embodiment can still be applied to these cases for further decreasing their power consumptions.

In summary, an image processing circuit of the display apparatus of the embodiment of the invention receives a first image signal of a frame time, and when an average gray level of the first image signal is greater than or equal to a first setting gray level, the image processing circuit reduces gray levels of the first image signal according to a first ratio to obtain a second image signal. Then, a data driving circuit of the display apparatus receives the second image signal and drives a display panel to display an image according to the second image signal. Compared with the conventional art, the embodiment of the invention can control the data driving circuit to output modified gray level voltage based on the gray levels of different display images, so that the display panel has lower driving current, thereby decreasing the power consumption of the display apparatus.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A display apparatus, comprising:
a display panel; and
a driving module electrically connected with the display panel and driving the display panel to display an image;
wherein, a luminance of lighted pixels of the display panel and a lighting area percentage of the display panel form a curve, a part of the curve before a first lighting area percentage has a first slope, a part of the curve after the first lighting area percentage has a second slope, and the absolute value of the second slope is greater than that of the first slope.

2. The display apparatus of claim 1, wherein the first lighting area percentage is between 10% and 30%.

3. The display apparatus of claim 1, wherein a part of the curve after a second lighting area percentage has a third slope, which is different from the second slope, and the second lighting area percentage is greater than the first lighting area percentage.

4. The display apparatus of claim 3, wherein the second lighting area percentage is between 65% and 75%.

5. The display apparatus of claim 3, wherein the absolute value of the second slope is greater than that of the third slope.

6. The display apparatus of claim 1, wherein the luminance of the lighted pixels of the display panel is a luminance of a highest gray level.
